(19) United States
(12) Patent Application Publication
(10) Pub. No.: US 2021/0138964 A1
(43) Pub. Date: May 13, 2021

(54) Storage System

(71) Applicant: Robert Bosch GmbH, Stuttgart (DE)

(72) Inventors: Thomas Weller, Leinfelden-Echterdingen (DE); Joern Stock, Leinfelden-Echterdingen (DE); Felix Lange, Leinfelden-Echterdingen (DE); Florian Esenwein, Leinfelden-Echterdingen (DE); Anna Heszler, Schwieberdingen (DE); Christopher Michael Barker, Leinfelden-Echterdingen (DE)

(21) Appl. No.: 16/498,410

(22) PCT Filed: Feb. 28, 2018
(86) PCT No.: PCT/EP2018/054875

§ 371 Date: Jan. 18, 2021

(30) Foreign Application Priority Data
Mar. 29, 2017 (DE) 10 2017 205 306.2

(51) Int. Cl. B60R 7/04; H04L 12/40; H04W 4/40

(52) U.S. Cl. CPC B60R 7/04; H04L 12/4011; B60R 2300/20; H04L 2012/40273; H04W 4/40

(57) ABSTRACT

A storage system includes at least one storage unit that is configured to store at least one working material and at least one sensor unit configured to sense at least one state characteristic of the working material stored in the storage unit. The storage system also includes an allocation unit that is configured at least to allocate the at least one detected state characteristic to at least one target state characteristic.

### PRIOR ART

A storage system having at least one storage unit, which is provided for the purpose of storing at least one work material, and having at least one sensor unit, which is provided for the purpose of capturing at least one state characteristic variable of the work material stored in the storage unit, has already been proposed.

### DISCLOSURE OF THE INVENTION

The invention is based on a storage system having at least one storage unit, which is provided for the purpose of storing at least one work material, and having at least one sensor unit, which is provided for the purpose of capturing at least one state characteristic variable of the work material stored in the storage unit.

It is proposed that the storage system comprises an assignment unit which is provided at least for the purpose of assigning the at least one captured state characteristic variable to at least one target state characteristic variable. As a result, the quantity and quality of a required work material can be advantageously compared with the quantity and quality of a work material which is actually available. In particular, this can prompt refilling and/or maintenance. In this context, a “work material” is intended to be understood as meaning, in particular, a tool, a machine tool, an accessory, a consumable, a workpiece and/or an item of work clothing. In this context, “state capture” is intended to be understood as meaning, in particular, capture of a presence, a filling level, an amount, a weight, a degree of wear and/or a state of charge.

The storage unit preferably forms a toolbox and/or a tool case. The state characteristic variable comprises, in particular, an item of information relating to an available quantity of the work material and/or an available quality of the work material. An item of information relating to a quantity of the work material may be, in particular, an item of weight information, an item of amount information and/or an item of information relating to a presence or absence of the work material. An item of information relating to a quality of the work material may comprise, in particular, an item of wear information, an item of state of charge information and/or an item of fault information. The target state characteristic variable comprises, in particular, an item of information relating to a required quantity of the work material and/or a required quality of the work material.

In this context, a “sensor unit” is intended to be understood as meaning, in particular, a unit which is provided for the purpose of recording at least one characteristic variable and/or a physical property, wherein the recording can take place actively, such as, in particular, by generating and emitting an electrical measurement signal, and/or passively, such as, in particular, by capturing property changes of a sensor component. In this context, the assignment may comprise, in particular, a comparison. In particular, the sensor unit may comprise a scanner, a receiver and/or a camera. In this case, it is conceivable for a camera integrated in the storage unit to generate at least one image of the work material and for this image to be evaluated internally and/or externally in order to detect the work materials, for example by means of outlines, barcodes etc., and/or to also determine a filling level by means of image evaluation. It is also conceivable for the at least one image to be available to a user and/or an administrator. The work material can therefore be advantageously displayed to the user and/or administrator. The at least one image is generated, for example, just before closing and/or during closing of the storage unit. As a result, the current state of the work material can always be available as an image. The term “provided” is intended to be understood as meaning, in particular, specially programmed, designed and/or equipped. The fact that an object is provided for a particular function is intended to be understood as meaning, in particular, that the object performs and/or carries out this particular function in at least one application and/or operating state.

Another configuration of the invention proposes that the at least one assignment unit comprises at least one computer unit which determines the at least one target state characteristic variable on the basis of an activity characteristic variable. This makes it possible to determine, in a particularly simple manner, whether a particular activity and/or task is with the available in the storage system. The activity characteristic variable preferably comprises task-based and/or activity-based information relating to work materials required for the task and/or activity. The activity characteristic variable is preferably stored in a database and/or is derived from activities and/or tasks which have already been carried out. In this case, it is conceivable for the activity characteristic variable to be manually selected by means of a keyword analysis, a database analysis and/or upon inputting an order, and/or to be supplemented with target state characteristic variables. The order can therefore be easily allocated to a particular user.

It is also proposed that the at least one assignment unit comprises an output unit which is provided for the purpose of outputting at least one item of allocation information on the basis of a relationship between the target state characteristic variable and the captured state characteristic variable. This makes it possible to advantageously output and take into account a discrepancy between a target state for an activity and an actual state for the activity. Accordingly, storage units with appropriate work materials can be quickly identified and used. In a similar manner, the use of a storage unit without appropriate work materials can be reliably avoided.

It is also proposed that the output unit comprises an external device, in particular a smartphone. This makes it possible to advantageously output the allocation information directly to a user independently of the position of the storage unit. In this context, “external” is intended to be understood as meaning, in particular, separate from the storage unit. The external device may also be in the form of a tablet, a mobile telephone and/or a laptop, in particular.

It is also proposed that the output unit comprises at least one optical display means which is arranged on the at least one storage unit and is provided for the purpose of optically outputting the at least one item of allocation information. This makes it possible to advantageously quickly identify required and/or unrequired storage units. The at least one optical display means is preferably undetachably arranged on the at least one storage unit.

It is also proposed that the at least one assignment unit comprises at least one communication unit which is provided for the purpose of wirelessly communicating with the at least one storage unit. As a result, the storage system can be operated in a particularly convenient manner. The communication unit is advantageously provided for wireless communication, in particular in accordance with a standard in the IEEE 802.11 family, in accordance with a standard according to IEEE 802.15.1, in accordance with a standard according to IEEE 802.15.4, in accordance with a ZigBee standard, in accordance with an RFID standard and/or an NFC standard. In this context, it is also conceivable for the communication unit to be provided for wired communication, in particular in accordance with a standard according to IEEE 802.3.

It is also proposed that the storage system comprises at least one further storage unit, which is provided for the purpose of storing at least one work material, and at least one further sensor unit, which is provided for the purpose of capturing at least one further state characteristic variable of work material stored in the further storage unit, wherein the assignment unit is provided for the purpose of assigning the at least one captured further state characteristic variable to the at least one target state characteristic variable. This makes it possible for the assignment unit to advantageously combine work materials from different storage units, in particular in a task-based manner. The storage system particularly preferably comprises a multiplicity of storage units.

It is also proposed that the at least one storage unit and the at least one further storage unit each have at least one communication unit which are provided for the purpose of communicating with one another. As a result, the storage units can be advantageously networked to one another. In particular, the at least one storage unit and the at least one further storage unit are provided for the purpose of directly communicating with one another. Furthermore, the at least one storage unit and the at least one further storage unit are provided for the purpose of communicating via the external device.

It is also proposed that the storage system comprises a vehicle inventory unit which is provided for the purpose of capturing at least one vehicle inventory characteristic variable via at least one storage unit arranged in a vehicle. This makes it possible to advantageously capture storage units available in a vehicle and their content. A discrepancy between required storage units and storage units available in the vehicle can be identified in a particularly reliable manner and can possibly be output via the output unit. The storage system preferably comprises a vehicle communication unit for transmitting, in particular wirelessly transmitting, the vehicle inventory characteristic variable to the assignment unit. In particular, the vehicle inventory characteristic variable comprises at least a number of storage units in the vehicle and/or a state of the work material in the storage units arranged in the vehicle. The vehicle may be formed, in particular, by a transporter, a truck, a van and/or an automobile. If a user does not have a permanently allocated vehicle, it is possible to advantageously indicate to the user, via the storage system, for example via a smartphone, what he must load a vehicle with so that he can fulfill his order.

A method for capturing the state of a storage system is also proposed, wherein at least one sensor unit of the storage system captures at least one state characteristic variable of a work material stored in a storage unit of the storage system in at least one method step, and wherein an assignment unit of the storage system assigns the at least one captured state characteristic variable to at least one target state characteristic variable in at least one method step. As a result, the quantity and quality of a required work material can be advantageously compared with the quantity and quality of a work material which is actually available. In particular, this may prompt refilling and/or maintenance.

In this case, the storage system according to the invention is not intended to be restricted to the above-described use and embodiment. In particular, the storage system according to the invention may have a number of individual elements, components and units which differs from a number mentioned herein in order to achieve a method of operation described herein.

### DRAWING

Further advantages emerge from the following description of the drawing. The drawing illustrates an exemplary embodiment of the invention. The drawing, the description and the claims contain numerous features in combination. A person skilled in the art will expediently also consider the features individually and will combine them to form useful further combinations.

In the drawing:

FIG. 1 shows a schematic illustration of a storage system,

FIG. 2 shows a further schematic illustration of the storage system, and

FIG. 3 shows a flowchart of a method for capturing the state of a storage system.

### DESCRIPTION OF THE EXEMPLARY EMBODIMENT

FIG. 1 shows a storage system having a storage unit 10. The storage unit 10 is provided for the purpose of storing a work material 16. The storage unit 10 comprises a toolbox, in particular for storing a tool. The work material 16 is formed here, by way of example, by a handheld power tool. The storage system comprises a sensor unit 22 which is provided for the purpose of capturing a state characteristic variable of the work material 16 stored in the storage unit 10. The sensor unit 22 is provided for the purpose of capturing a presence of the work material 16. The sensor unit 22 is provided for the purpose of capturing a state of charge of the work material 16. In this case, the state of charge is a capacity of a rechargeable battery of the handheld power tool. The state characteristic variable comprises the information relating to the presence of the work material 16 and/or the state of charge of the work material 16.

However, in this context, it is also conceivable for the sensor unit 22 to comprise another status of the handheld power tool, such as, in particular, maintenance and/or testing information, anomalies of the handheld power tool with respect to particular components, for example excessive or noticeable vibrations of a ball bearing or operating parameters being exceeded and/or undershot in particular work situations, for example a current, a voltage and/or a rotational speed. In this case, communication between the storage unit 10 and the handheld power tool by means of NFC, WLAN, Bluetooth etc. is conceivable.

The storage system comprises a further storage unit 12. The further storage unit 12 is provided for the purpose of storing a work material 18. The further storage unit 12 comprises an accessory box, in particular for storing tool accessories. The work material 18 is formed here, by way of example, by extraction hoods, insertion tools, guide rails and/or additional rechargeable batteries. The storage system comprises a further sensor unit 24 which is provided for the purpose of capturing a further state characteristic variable of the work material 18 stored in the further storage unit 12. The further sensor unit 24 is provided for the purpose of capturing a presence of the work material 18. The state characteristic variable comprises the information relating to the presence of the work material 18.

The storage unit 10 and the further storage unit 12 each have a communication unit 40, 42 provided for the purpose of communicating with one another. The storage units 10, are networked to one another using data technology. The communication unit 40 is provided for the purpose of directly communicating with the communication unit 42.

The storage system comprises a third storage unit 14. The third storage unit 14 is provided for the purpose of storing a work material 20. The third storage unit 14 comprises a consumables box, in particular for storing a consumable, such as, in particular, screws, dowels, nuts, clamps, electrical components, fuses, luster terminals, connectors, switches, pipe elements, connecting pieces, holders, brackets and/or nails. The storage system comprises a third sensor unit 26 which is provided for the purpose of capturing a third state characteristic variable of the work material 20 stored in the third storage unit 14. The third sensor unit 26 is provided for the purpose of capturing a filling level and/or a weight of the work material 20. The state characteristic variable comprises the information relating to the filling level and/or weight of the work material 20. The third storage unit 14 has a communication unit 44 which is provided for the purpose of communicating with the communication units 40, 42.

The storage system comprises an assignment unit 28. The assignment unit 28 is provided for the purpose of assigning the captured state characteristic variable to a target state characteristic variable. The assignment unit is also provided for the purpose of assigning the captured further state characteristic variable to the target state characteristic variable. The assignment unit 28 is also provided for the purpose of assigning the captured third state characteristic variable to the target state characteristic variable. The assignment unit 28 comprises a computer unit 30.

The computer unit 30 determines the target state characteristic variable on the basis of an activity characteristic variable. The activity characteristic variable describes a relationship between a task or an activity and the work materials 16, 18, 20 required for the task/activity and/or the state of said materials. The activity characteristic variable can be stored, for example, in an external database 50 which can be accessed by the assignment unit 28. On the basis of activity and task descriptions, the database 50 can be used, for example by the assignment unit 28, to determine which work materials 16, 18, 20 are required. A check is carried out in order to determine whether these materials are available and missing work materials 16, 18, 20 are displayed. The storage system may additionally also prompt refilling, maintenance and/or repair. The storage units 10, 12, 14 each comprise a unique identifier. The identifier can be assigned to particular activity characteristic variables. Appropriate storage units 10, 12, 14 can therefore be deliberately output for a particular activity. In this case, it is conceivable for the corresponding storage units 10, 12, 14 to have already been reserved for the user and for no other users to be able and/or allowed to remove these units, for example from the warehouse.

The assignment unit 28 comprises a smartphone. However, in this context, it is also conceivable for the assignment unit 28 to comprise a computer or another data-processing means. The assignment unit 28 is connected to the database 50 and/or to other assignment units 52, 54, 56.

The assignment unit 28 comprises an output unit 32. The output unit 32 comprises an external device. The output unit 32 comprises a smartphone. In this case, the assignment unit 28 and the output unit 32 comprise the same smartphone. The output unit 32 is provided for the purpose of outputting at least one item of allocation information on the basis of a relationship between the target state characteristic variable and the captured state characteristic variable. In this case, the allocation information can also be determined by the assignment unit 28. The allocation information contains, in particular, an item of information relating to which of the storage units 10, 12, 14 can be used. Required and usable storage units 10, 12, 14 can be allocated to a user.

The output unit 32 comprises an optical display means 34. The display means 34 is arranged on the storage unit 10 and is provided for the purpose of optically outputting the allocation information. The output unit 32 comprises a further optical display means 36. The further display means 36 is arranged on the further storage unit 12 and is provided for the purpose of optically outputting the allocation information. The output unit 32 comprises a third optical display means 38. The third display means 38 is arranged on the third storage unit 14 and is provided for the purpose of optically outputting the allocation information. If a user enters a warehouse, it is conceivable for his required storage units 10, 12, 14 to be selected via the assignment unit 28. The respective display means 34, 36, 38 then display whether the assigned storage units 10, 12, 14 are required. In this case, it is conceivable for the respective display means 34, 36, 38 to flash, emit light etc. with a particular color or to provide another signal. A user can therefore remove the required storage units 10, 12, 14 from the warehouse in a purposeful manner. Alternatively, it is also possible for the storage units 10, 12, 14 to be assembled from an automatic high bay warehouse and to be transferred to the user.

The assignment unit 28 comprises a communication unit 62 which is provided for the purpose of wirelessly communicating with the storage unit 10. The communication unit 62 is also provided for the purpose of communicating with the storage units 12, 14. As also described, the communication unit 62 is provided for the purpose of communicating with further networked products 60, for example a hammer drill and/or a percussion hammer or another.

As shown in FIG. 2, the storage system also comprises a vehicle inventory unit 46. The vehicle inventory unit 46 is provided for the purpose of capturing a vehicle inventory characteristic variable via at least one storage unit 10, 12, 14 arranged in a vehicle 48. The vehicle inventory unit 46 is provided for the purpose of identifying a discrepancy between required storage units 10, 12, 14 and storage units 10, 12, 14 available in the vehicle 48. The storage system comprises a vehicle communication unit 58 for transmitting, in particular wirelessly transmitting, the vehicle inventory characteristic variable to the assignment unit 28. The vehicle communication unit 58 is arranged inside the vehicle 48. The vehicle communication unit 58 is also provided for the purpose of communicating with various communication participants arranged, in particular, in a factory, an external server, on a handheld power tool, on an item of work clothing, in particular a shoe, or a tool.

The vehicle inventory unit 46 can be used to ensure that vehicles are and/or have been correctly loaded, for example. It is also conceivable that it is determined which vehicle from a selection of vehicles, for example belonging to a company, can undertake an order since they are carrying the required storage units 10, 12, 14. In this case, it is conceivable for the state characteristic variable of the storage units 10, 12, 14 or the vehicle inventory characteristic variable to be transmitted to the assignment unit 28 in real time and/or to be displayed by the output unit 32 in real time and/or with a slight time delay. It would therefore be possible to assess, from a control center, whether the vehicle 48 can undertake an order, for example in an emergency.

The assignment and/or selection can be carried out automatically via the storage system. In this context, it is also conceivable for location data relating to the vehicle 48 to be compared, for example by means of GPS data, route planners etc., and for an employee with a shortest detour and/or a lowest expenditure of time to be selected, for example. Furthermore, maintenance work or refilling of work materials 16, 18, 20 can be prepared in a preventive manner. For example, a replacement device can be obtained or held or consumables can accordingly be reordered if the state characteristic variable no longer corresponds to the target state characteristic variable, but rather is smaller, in particular. If an employee with his vehicle 48 returns to a company, these replacement devices and/or consumables can be made available to him. It is also conceivable for the employee to be requested, in particular by means of a notification using the output unit 32, to bring the vehicle 48 to a service station where his vehicle 48 is filled and serviced with regard to its content. Devices which are due for maintenance and/or have anomalies and should be repaired can be replaced, for example.

In a method for capturing the state of the storage system, a state characteristic variable of a work material 16, 18, 20 stored in a storage unit 10, 12, 14 of the storage system is captured by means of at least one of the sensor units 22, 24, 26 of the storage system in a method step 100. The assignment unit 28 of the storage system assigns the captured state characteristic variable to a target state characteristic variable in a next method step 101. The target state characteristic variable is determined by a computer unit 30 on the basis of an activity characteristic variable. The storage units 10, 12, 14 can therefore be assigned to different activities, work and/or components. If a user receives an order to carry out an activity, for example install fittings, the storage system may allocate at least one storage unit 10, 12, 14. The user receives the corresponding storage unit 10, 12, 14. The output unit 32 outputs the allocation information on the basis of a relationship between the target state characteristic variable and the captured state characteristic variable in a next method step 102. In this context, it is also conceivable for the user to indicate his vehicle 48 before leaving, for example by means of a scan, in which case he is advised if a corresponding storage unit 10, 12, 14 is not available and must also be loaded by him.

1. A storage system, comprising:
at least one storage unit configured to store at least one work material;
at least one sensor unit configured to capture at least one state characteristic variable of the work material stored in the storage unit; and
an assignment unit configured at least to assign the at least one captured state characteristic variable to at least one target state characteristic variable.

2. The storage system as claimed in claim 1, wherein the at least one assignment unit comprises at least one computer unit that determines the at least one target state characteristic variable on the basis of an activity characteristic variable.

3. The storage system as claimed in claim 1, wherein the at least one assignment unit comprises an output unit configured to output at least one item of allocation information on the basis of a relationship between the target state characteristic variable and the captured state characteristic variable.

4. The storage system as claimed in claim 3, wherein the output unit comprises an external device.

5. The storage system as claimed in claim 3, wherein the output unit comprises at least one optical display device that is arranged on the at least one storage unit and is configured to optically output the at least one item of allocation information.

6. The storage system as claimed in claim 1, wherein the at least one assignment unit comprises at least one communication unit that is configured to wirelessly communicate with the at least one storage unit.

7. The storage system as claimed in claim 1, further comprising:
at least one further storage unit configured to store at least one work material; and
at least one further sensor unit configured to capture at least one further state characteristic variable of work material stored in the further storage unit,
wherein the assignment unit is configured to assign the at least one captured further state characteristic variable to the at least one target state characteristic variable.

8. The storage system as claimed in claim 7, wherein the at least one storage unit and the at least one further storage unit each have at least one communication unit, the respective communication units configured to communicate with one another.

9. The storage system as claimed in claim 1, further comprising a vehicle inventory unit that is configured to capture at least one vehicle inventory characteristic variable via at least one storage unit arranged in a vehicle.

10. A method for capturing the state of a storage system that includes at least one storage unit, at least one sensor unit, and at least one assignment unit, the method comprising:
capturing with the at least one sensor unit at least one state characteristic variable of a work material stored in the at least one storage unit; and
assigning with the at least one assignment unit the at least one captured state characteristic variable to at least one target state characteristic variable.

11. The storage system as claimed in claim 4, wherein the external device is configured as a smartphone.
